(19) United States
(12) Patent Application Publication
(10) Pub. No.: US 2013/0271488 A1
(43) Pub. Date: Oct. 17, 2013

(54) METHOD AND APPARATUS FOR FILTERING AND TRANSMITTING VIRTUAL OBJECTS

(71) Applicants: Vlad Alexandru Stirbu, Tampere (FI); Yu You, Kangasala (FI)

(72) Inventors: Vlad Alexandru Stirbu, Tampere (FI); Yu You, Kangasala (FI)

(73) Assignee: Nokia Corporation, Espoo (FI)

(21) Appl. No.: 13/445,604

(22) Filed: Apr. 12, 2012

(51) Int. Cl. G09G 5/00

(52) U.S. Cl. 345/619

(57) ABSTRACT

An approach is provided for filtering and delivering user-defined virtual content to augmented and/or mixed reality mobile applications. The application client processes and/or facilitates a processing of one or more map tiles to determine one or more parameters describing, at least in part, one or more areas bounded by the one or more map tiles, wherein the one or more map tiles are received from at least one provider. The application client then causes, at least in part, a transmission of one or more requests for content to at least one other provider, wherein the one or more requests specify, at least in part, the one or more parameters for transforming the content.

### BACKGROUND

Service providers and device manufacturers (e.g., wireless, cellular, etc.) are continually challenged to deliver value and convenience to consumers by, for example, providing compelling network services. One area of interest has been the development of virtual environments such as Mirror Worlds. A Mirror World is a geographically accurate representation of real-world structures in a digital form. In particular, Mirror Worlds offer a utilitarian software model of real-world environments and their workings and can enable interactions that are difficult in real-world situations due to cost, time, resources, etc. Examples of Mirror Worlds based on drive-imagery include NOKIA CITY SCENE and GOOGLE STREET VIEW. Moreover, Mirror Worlds can be personalized, enhanced, and/or augmented with third-party and/or user-generated content (e.g., three-dimensional models, geo-tagged data, user review information, etc.). However, the three-dimensional content (e.g., digital models and associated textures) tends to comprise large file sizes. As a result, delivering the content to an augmented and/or mixed reality application running on a mobile device (e.g., a mobile phone or tablet) can be expensive and time consuming in terms of bandwidth and inefficient in terms of memory allocation on the device. Therefore, service providers and device manufacturers face significant technical challenges in providing a service that allows users to obtain location-based three-dimensional content in an efficient and cost effective manner.

### SOME EXAMPLE EMBODIMENTS

Therefore, there is a need for an approach for filtering and delivering user-defined virtual content to augmented and/or mixed reality mobile applications.

According to one embodiment, a method comprises processing and/or facilitating a processing of one or more map tiles to determine one or more parameters describing, at least in part, one or more areas bounded by the one or more map tiles, wherein the one or more map tiles are received from at least one provider. The method also comprises causing, at least in part, a transmission of one or more requests for content to at least one other provider, wherein the one or more requests specify, at least in part, the one or more parameters for transforming the content.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of one or more map tiles to determine one or more parameters describing, at least in part, one or more areas bounded by the one or more map tiles, wherein the one or more map tiles are received from at least one provider. The apparatus is also caused to cause, at least in part, a transmission of one or more requests for content to at least one other provider, wherein the one or more requests specify, at least in part, the one or more parameters for transforming the content.

According to another embodiment, a computer-readable storage medium carries one or more sequences of one or more instructions which, when executed by one or more processors, cause, at least in part, an apparatus to process and/or facilitate a processing of one or more map tiles to determine one or more parameters describing, at least in part, one or more areas bounded by the one or more map tiles, wherein the one or more map tiles are received from at least one provider. The apparatus is also caused to cause, at least in part, a transmission of one or more requests for content to at least one other provider, wherein the one or more requests specify, at least in part, the one or more parameters for transforming the content.

According to another embodiment, an apparatus comprises means for processing and/or facilitating a processing of one or more map tiles to determine one or more parameters describing, at least in part, one or more areas bounded by the one or more map tiles, wherein the one or more map tiles are received from at least one provider. The apparatus also comprises means for causing, at least in part, a transmission of one or more requests for content to at least one other provider, wherein the one or more requests specify, at least in part, the one or more parameters for transforming the content.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of filtering and delivering user-defined virtual content to augmented and/or mixed reality mobile applications, according to one embodiment;

FIG. 2 is a diagram of the components of an application client, according to one embodiment;

FIG. 3 is a flowchart of a process for filtering and delivering user-defined virtual content to augmented and/or mixed reality mobile applications, according to one embodiment;

FIG. 4 is a diagram of an example application scenario utilized in the processes of FIG. 3, according to various embodiments;

FIG. 5 is a diagram of a user interface utilized in the processes of FIG. 3, according to various embodiments

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for filtering and delivering user-defined virtual content to augmented and/or mixed reality mobile applications are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

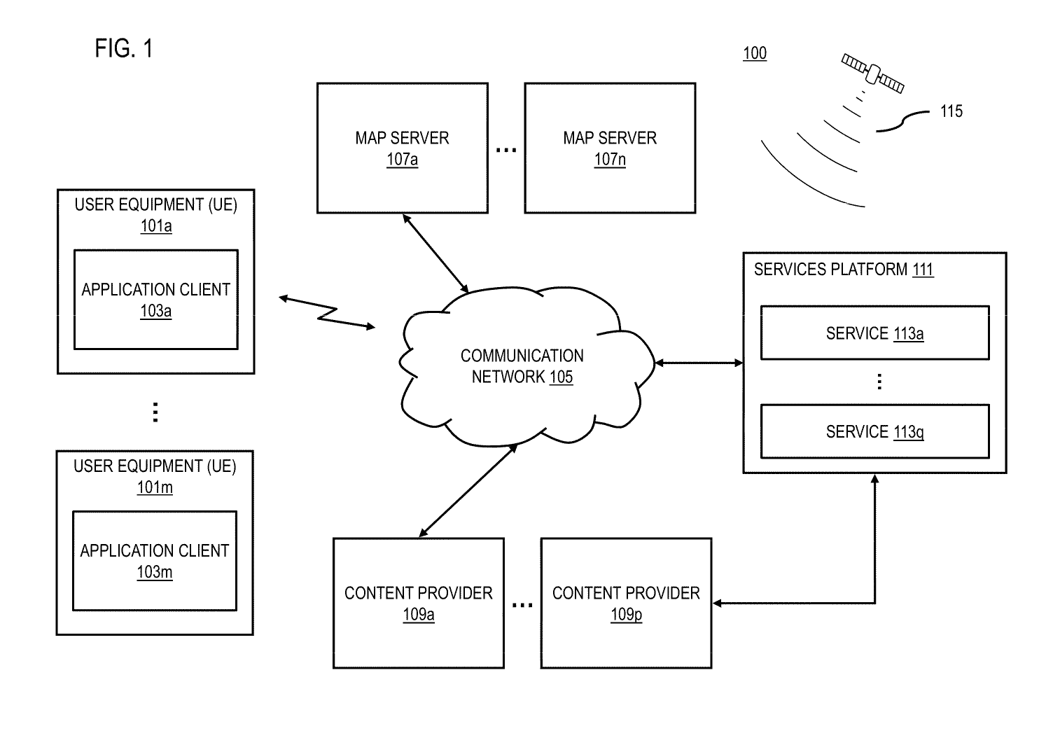

FIG. 1 is a diagram of a system capable of filtering and delivering user-defined virtual content to augmented and/or mixed reality mobile applications, according to one embodiment. As previously discussed, Mirror Worlds offer a utilitarian software model of real-world environments and their workings and can enable interactions that are difficult in real-world situations due to cost, time, resources, etc. Examples of Mirror Worlds based on drive-imagery include NOKIA CITY SCENE and GOOGLE STREET VIEW. Moreover, Mirror Worlds can be personalized, enhanced, and/or augmented with third-party and/or user-generated content (e.g., three-dimensional models, geo-tagged data, user review information, etc.). However, the three-dimensional content (e.g., digital models and associated textures) tends to comprise large file sizes. As a result, delivering the content to an augmented and/or mixed reality application running on a mobile device (e.g., a mobile phone or tablet) can be expensive and time consuming in terms of bandwidth and inefficient in terms of memory allocation on the device. Therefore, service providers and device manufacturers face significant technical challenges in providing a service that allows users to obtain location-based three-dimensional content in an efficient and cost effective manner.

To address this problem, a system 100 of FIG. 1 introduces the capability to filter and deliver user-defined virtual content to augmented and/or mixed reality mobile applications. More specifically, in one embodiment, the system 100 running an augmented and/or mixed reality mobile application on a mobile device (e.g., a mobile phone or a tablet) first makes a request to one or more map servers (e.g., a server associated with the mobile device's service provider or carrier) for location-based data (e.g., map data) associated with the location of the mobile device by indicating a position or rectangle of interest using one or more location-based technologies associated with the mobile device (e.g., global positioning system (GPS) receivers, cellular triangulation, assisted-GPS (A-GPS), etc.). In response to the request, the one or more map servers return to the system 100 one or more map tiles (e.g., covering several 100 meters) containing location-based data associated with the area requested (e.g., three-dimensional model of the city, terrain mesh, and textures). In one embodiment, the system 100 processes the one or more map tiles to determine one or more parameters describing the one or more areas bounded by the one or more map tiles. More specifically, the one or more parameters may include one or more bounding box coordinates (e.g., x-y coordinates), one or more levels of detail (e.g., zoom levels), a field of view, or a combination thereof based on context information associated with the mobile device.

In one embodiment, once the system 100 determines the one or more parameters, the system 100 transmits one or more requests for additional content (e.g., three-dimensional models, geo-tagged data, user review information, etc.) from at least one other provider (i.e., separate and apart from the one or more entities providing the one or more map tiles) that the system 100 can then use to substitute for, enhance, or a combination thereof the content already provided by the one or more map servers. It is contemplated that the same entity may provide both a map server and a content server, however, in the typical use case, one entity (e.g., the service provider) would provide the map server and another entity (e.g., a third-party content provider) would provide the content server.

By way of example, the at least one other provider may have one or more matching objects (e.g., one or more geo-data models) stored on one or more content servers corresponding to the requested coordinates that can then be skinned by the system 100 in the augmented and/or mixed reality application. However, the one or more models may comprise numerous three-dimensional models and may be much larger geographically than the area of interest indicated by the system 100. Therefore, in one embodiment, the system 100 causes the content server to first filter, clip, or a combination thereof (i.e., transform) the one or more models and then transmit back to the system 100 (e.g., using Keyhole Markup Language (KML)) only the three-dimensional model that is contained in the specified area of interest.

In one embodiment, the system 100 determines the at least one other provider, the content, or a combination thereof based on one or more themes for rendering the one or more map tiles. For example, the system 100 can contact a particular content server in order to skin a whole city to look like a medieval town, bring in new layers of point of interest (POI) information (e.g., geo-tagged labels), or even construct structures that do not exist in the real world.

In one embodiment, once the system 100 receives the transformed content from the at least one other provider (e.g., a third-party provider), the system 100 causes a rendering of the transformed content in the augmented and/or mixed reality application. More specifically, the system 100 incorporates the transformed object (e.g., a three-dimensional model) into the scene graph of the augmented and/or mixed reality application and then renders the resulting skinned building. In addition to rendering the transformed content, the system 100 may optionally cause a presentation of one or more notifications associated with the transformed content, the original content, or a combination thereof (e.g., “not a complete part of the model”). By way of example, if the system 100 determines that a large structure (e.g., a large governmental building or museum) is located within the requested map tile, but only the east façade of the building is visible based on the location-based technologies associated with the mobile device, the system 100 can cause the content provider to clip the remaining portions of the three-dimensional model and then render the transformed object with the notification “not a complete part of the model.” In addition, in one embodiment, the system 100 may cause a rendering of the transformed content for a predetermined period (e.g., one to two minutes), a duration of one or more contexts (e.g., based on GPS coordinates associated with the mobile device), at least the rendering of the other content (e.g., the running of the augmented and/or mixed reality application), or a combination thereof. Further, in one embodiment, the system 100 may determine based, at least in part, on one or more data connections (e.g., an availability of a Wireless Fidelity (WiFi) connection), computational resources (e.g., a tablet versus a mobile phone), or a combination thereof to override the one or more parameters for transforming the content. As a result, the at least one other provider would transmit the entire three-dimensional model (e.g., a City Hall building) to the system 100 for rendering in the augmented and/or mixed reality application.

As shown in FIG. 1, the system 100 comprises one or more user equipment (UE) 101a-101m (e.g., a mobile phone or tablet) (also collectively referred to as UEs 101) containing one or more application clients 103a-m (e.g., an augment and/or mixed reality client, a mirror world clients, etc.) (also collectively referred to as application clients 103) having connectivity to one or more map servers 107a-n (e.g., a server associated with the UE 101's service provider or carrier) (also collectively referred to as map servers 107) via a communication network 105. The map servers may contain location-based data (e.g., map data) associated with various geographic areas (e.g., a three-dimensional model of a city, terrain mesh, and textures). The UEs 101 also have connectivity to one or more content servers 109a-p (e.g., associated with one or more third-party content providers) (also collectively referred to as content servers 109). The content servers 109 may contain content used in one or more augmented and/or mixed reality applications, one or more three-dimensional models (e.g., a City Hall building), one or more three-dimensional panoramas, etc. While it is contemplated that the same entity may provide both a map server 107 and a content server 109, in the typical use case, one entity (e.g., the service provider) would provide a map server 107 and another entity (e.g., a third-party content provider) would provide a content server 109.

The system 100 also includes a services platform 111 that provides one or more services 113a-113r (also collectively referred to services 113) to the components of the system 100. The services 113 may include a wide variety of services such as content provisioning services that provision one or more virtual models (e.g., a three-dimensional model of a government building or museum), one or more representations of the real world for augmentation (e.g., one or more three-dimensional panoramic images), one or more viewpoints, etc. The services 113 may also include navigation services, mapping services, social networking services, location-based services, etc.

In certain embodiments, an application client 103 of a UE 101 may utilize location-based technologies (GPS, cellular triangulation, A-GPS, etc.) to make a request to one or more map servers 107 for location-based data (e.g., three-dimensional models, terrain mesh, and textures) based on a position or rectangle of interest relative to the UE 101. For example, a UE 101 may include a GPS receiver to obtain geographic coordinates from satellites 115 to determine its current location.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101 can support any type of interface to the user (such as “wearable” circuitry, etc.).

In one embodiment, an application client 103 associated with and/or running an augmented and/or mixed reality application on a UE 101 (e.g., a mobile phone or tablet), first makes a request to one or more map servers (e.g., a server associated with the UE 101's service provider or carrier) for location-based data (e.g., map data) associated with the location of the UE 101 by indicating a position or rectangle of interest using one or more location-based technologies associated with the UE 101 (e.g., GPS receivers and the satellites 115). In response, the one or more map servers return to the application client 103 one or more map tiles (e.g., covering several 100 meters) containing location-based data associated with the area requested (e.g., a three-dimensional model of a city, terrain mesh, and textures). In one embodiment, the application client 103 processes the one or more map tiles to determine one or more parameters describing the one or more areas bounded by the one or more map tiles. More specifically, the one or more parameters may include one or more bounding box coordinates (e.g., x-y coordinates), one or more levels of detail (e.g., zoom levels), a field of view, or a combination thereof based on context information associated with the UE 101.

In one embodiment, once the application client 103 determines the one or more parameters, the application client 103 transmits one or more requests for additional content (e.g., three-dimensional models, geo-tagged data, user review information, etc.) from at least one other provider that the application client 103 can then use to substitute for, enhance, or a combination thereof the content already provided by the one or more map servers. As previously discussed, it is completed that the same entity may provide both a map server and a content server, however, in the typical use case, one entity (e.g., the service provider) would provide the map server and another entity (e.g., a third-party content provider) would provide the content server.

In a sample use case, the at least one other provider may have one or more matching objects (e.g., one or more geo-data models) stored on one or more content servers corresponding to the requested coordinates that can then be skinned by the application client 103 in the augmented and/or mixed reality application. However, the one or more geo-data models may comprise numerous three-dimensional models and may be much larger geographically than the area of interest indicated by the application client 103. Therefore, in one embodiment, the application client 103 causes the content server to first filter, clip, or a combination thereof (i.e., transform) the one or more models and then transmit back to the application client 103 (e.g., using KML) only the three-dimensional model that is contained in the specified area of interest.

In one embodiment, the application client 103 determines at least one other provider, the content, or a combination thereof based on one or more themes for rendering the one or more map tiles. By way of example, the application client 103 can contact a particular content server in order to skin a whole city to look like a medieval town, enhance a map with new layers of POI information (e.g., geo-tagged labels), or even construct structures that do not exist in the real world.

In one embodiment, once the application client 103 receives the transformed content from the at least one other provider (e.g., a third-party content provider), the application client 103 causes a rendering of the transformed content at the UE 101 running the augmented and/or mixed reality application. More specifically, the application client 103 incorporates the transformed object (e.g., a three-dimensional model) into the scene graph of the augmented and/or mixed reality application and then renders the resulting skinned building. In addition to rendering the transformed content, the application client 103 may optionally cause a presentation of one or more notifications associated with the transformed content, the original content, or a combination thereof (e.g., “not a complete part of the model”). Further, in one embodiment, the application client 103 may cause a rendering of the transformed content for a predetermined period (e.g., one to two minutes), a duration of one or more contexts (e.g., based on GPS coordinates associated with the UE 101), at least the rendering of the other content (e.g., the running of the augmented and/or mixed reality application), or a combination thereof. In addition, in one embodiment, the application client 103 may determine based on one or more data connections (e.g., a WiFi connection), computation resources (e.g., a tablet versus a mobile phone), or a combination thereof to override the one or more parameters for transforming the content. As a result, the one or more content servers would transmit the entire three-dimensional model (e.g., a City Hall building) to the application client 103 for rendering in an augmented and/or mixed reality application of the UE 101.

By way of example, the UEs 101, application clients 103, the map servers 107, the content servers 109, the services platform 111, the services 113, and the satellites 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

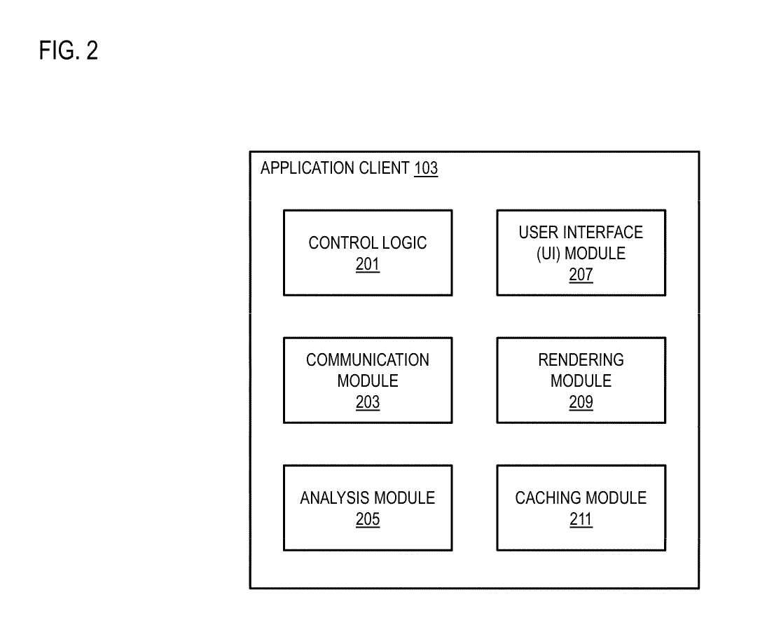

FIG. 2 is a diagram of the components of an application client 103, according to one embodiment. By way of example, the application client 103 includes one or more components for filtering and delivering user-defined virtual content to augmented and/or mixed reality mobile applications. It is contemplated that the functions of these components may be combined in one or more components or performed by other components of equivalent functionality. In this embodiment, the application client 103 includes a control logic 201, a communication module 203, an analysis module 205, a user interface (UI) module 207, a rendering module 209, and a caching module 211.

The control logic 201 oversees task, including tasks performed by the communication module 203, the analysis module 205, the user interface module 207, the rendering module 209, and the caching module 211. For example, although the other modules may perform the actual task, the control logic 201 may determine when and how those tasks are performed or otherwise direct the other modules to perform the task.

The communication module 203 is used for communication between the application clients 103 of the UEs 101 and the map servers 107, the content severs 109, the services platform 111, the services 113, and the satellites 115. The communication module 203 may also be used in connection with the user interface (UI) module 207 to determine at least one other provider (e.g., a third-party content provider), additional content (e.g., three-dimensional models, geo-tagged data, user review information, etc.), or a combination based on one or more themes for rendering the one or more map tiles. By way of example, the communication module 203 may be used to content a particular content server 109 in order to skin a whole city to look like a medieval town. The communication module 203 also may be used to transmit the one or more requests for additional content to at least one other provider (e.g., the content servers 109), wherein the one or more requests specify the one or more parameters for transforming the content. Further, the communication module 203 may be used to cause the content servers 109 to cause a filtering, a clipping, or a combination thereof of one or more models from the at least one other provider.

The analysis module 205 is used to process the one or more map tiles (e.g., from the map servers 107) to determine one or more parameters describing one or more areas bounded by the one or more map tiles. More specifically, the one or more parameters may include one or more bounding box coordinates (e.g., x-y coordinates), one or more levels of detail (e.g., zoom levels), a field of view, or a combination thereof based on the context information associated with a mobile device (e.g., a UE 101) rendering the transformed content.

The user interface (UI) module 207 is used to determine one or more themes for rendering the one or more map tiles. By way of example, an end user may use a user interface of a mobile device (e.g., a graphic user interface (GUI)) to determine to skin a whole city to look like a medieval town, to enhance a map with new layers of POI information (e.g., geo-tagged labels), or even to construct structures that do not exist in the real world. The user interface module 207, in connection with the rendering module 209, may also be used to cause a rendering of the transformed content for a predetermined period (e.g., one or two minutes), a duration of one or more contents (e.g., based on GPS coordinates associated with the UE 101), at least the rendering of the other content (e.g., the running of the augmented and/or mixed reality application) or a combination thereof. Further, the user interface module 207 also may be used to override the one or more parameters for transforming the content based, at least in part, on one or more data connections (e.g., an available WiFi connection), computational resources (e.g., a tablet versus a mobile phone), or a combination thereof.

The rendering module 209 is used to render the transformed content transmitted by at least one other provider, wherein the rendering of the transformed content substitutes for, enhances, or a combination thereof other content associated with the one or more map tiles (e.g., content associated with an augmented and/or mixed reality application). The rendering module 209 may also be used in connection with the user interface module 207 and the caching module 211 to cause a presentation of one or more notifications associated with the transformed content, the other content, or a combination thereof (e.g., “not a complete part of the model”).

The caching module 211 may be used to cache the one or more notifications associated with the transformed content, the other content (e.g., content associated with the one or more augmented and/or mixed reality applications), or a combination thereof. The caching module 211 may also be used to cache one or more map tiles containing location-based data (e.g., map data) associated with the area requested by the communication module 203 (e.g., a three-dimensional model of a city, terrain mesh, and textures), one or more indexes associated with the one or more map tiles, or a combination thereof. The caching module 211 also may be used to cache the one or more parameters associated with the one or more map tiles (e.g., bounding box coordinates, one or more levels of detail, a field of view, or a combination thereof). Further, the caching module 211 may also be used to cache one or more transformed objects (e.g., filtered geo-data) while portions of the transformed content are being used in an augmented and/or mixed reality application.

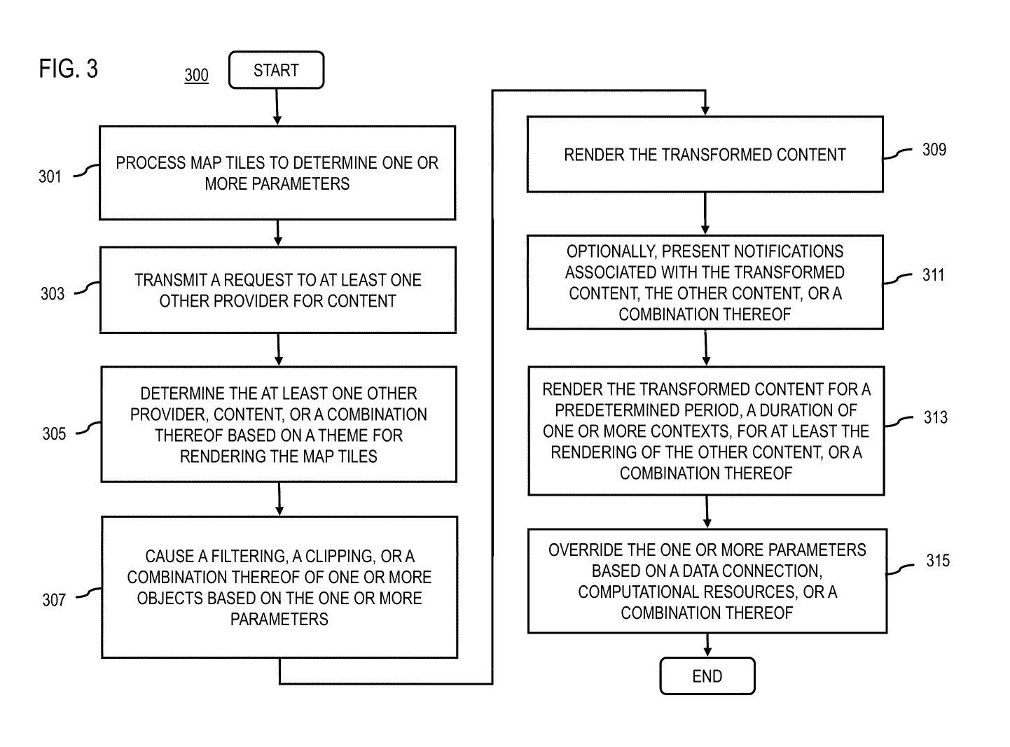

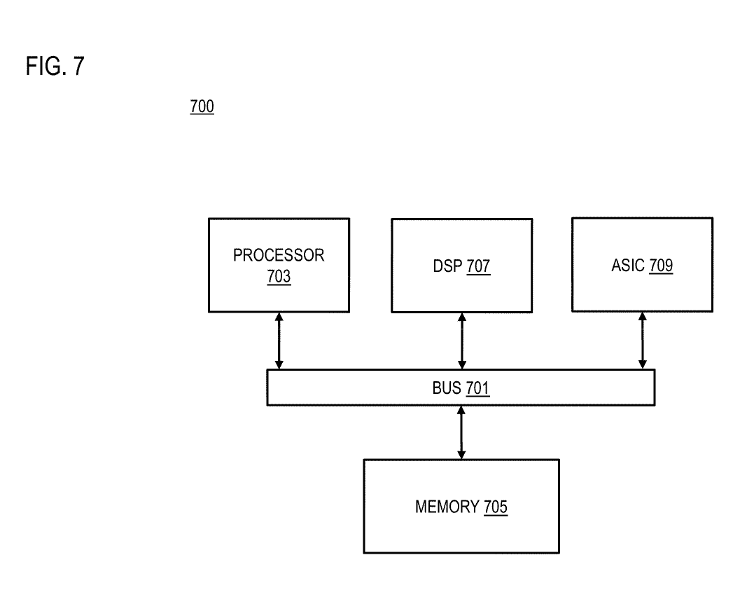

FIG. 3 is a flowchart of a process for filtering and delivering user-defined virtual content to augmented and/or mixed reality mobile applications, according to one embodiment. In one embodiment, the application client 103 performs the process 300 and is implemented in, for instance, a chip set including a processor and a memory as shown in FIG. 7. In step 301, the application client 103 processes and/or facilitates a processing of one or more map tiles to determine one or more parameters describing, at least in part, one or more areas bounded by the one or more map tiles, wherein the one or more map tiles are received from at least one provider. By way of example, the application client 103 running an augmented and/or mixed reality mobile application on a mobile device (e.g., a mobile phone or tablet) first makes a request to one or more map servers (e.g., a server associated with the mobile device's service provider or carrier) for location-based data (e.g., map data) associated with the location of the mobile device by indicating a position or rectangle of interest use one or more location-based technologies associated with the mobile device. In response to the request, the one or more map servers return to the application client 103 one or more map tiles (e.g., covering several 100 meters) containing location-based data associated with an area (e.g., a three-dimensional model of a city, terrain mesh, and textures). In one embodiment, the application client 103 then processes the one or more map tiles to determine one or more parameters describing the one or more areas bounded by the one or more map tiles. By way of example, the one or more parameters may include one or more bounding box coordinates (e.g., x-y coordinates), one or more levels of detail (e.g., zoom levels), a field of view, or a combination thereof based on context information associated with the mobile device running the application client 103.

In step 303, the application client 103 causes, at least in part, a transmission of one or more requests for content to at least one other provider, wherein the one or more requests specify, at least in part, the one or more parameters for transforming the content. By way of example, the content requested may include three-dimensional models, geo-tagged data, user review information from at least one other provider that is separate and apart from the one or more entities providing the one or more map tiles. As previously discussed, the one or more parameters may include one or more bounding box coordinates, one or more levels of detail, at least one field of view, or a combination thereof based on context information associated with the mobile device running the application client 103. In addition, while it is contemplated that the same entity may provide both a map server and a content server, in the typical use case, one entity (e.g., the service provider) would provide the map server and another entity (e.g., a third-party content provider) would provide the content server.

In step 305, the application client 103 determines the at least one other provider, the content, or a combination thereof based, at least in part, on one or more themes for rendering the one or more map tiles. By way of example, the application client 103 can contact a particular content server in order to skin a whole city to look like a medieval town, bring in new layers of point of interest (POI) information (e.g., geo-tagged labels), or even construct structures that do not exist in the real world.

In step 307, the application client 103 causes, at least in part, a filtering, a clipping, or a combination thereof of one or more objects from the at least one other provider based, at least in part, on the one or more parameters to determine the transformed content. By way of example, the at least one other provider may have one or more matching objects (e.g., one or more geo-data models) stored on one or more content servers corresponding to the requested coordinates that can then be skinned by the application client 103 in the augmented and/or mixed reality application. However, the one or more models may comprise numerous three-dimensional models and may be much larger geographically than the area of interest indicated by the application client 103. In addition, the application client 103 may determine that only a portion of the three-dimensional model (e.g., the east façade) is visible based on the location-based technologies associated with the application client 103. Therefore, in one embodiment, the application client 103 causes the content server to first filter, clip, or a combination thereof (i.e., transform) the one or more models and then transmit back to the application client (e.g., using KML) only the three-dimensional model that is contained in the specified area of interest.

In step 309, the application client 103 causes, at least in part, a rendering of the transformed content, wherein the rendering of the transformed content substitutes for, enhances, or a combination thereof other content associated with the one or more map tiles. By way of example, the application client 103 may incorporate the transformed content (e.g., a three dimensional model) into the scene graph of the augmented and/or mixed reality application then render the resulting skinned building.

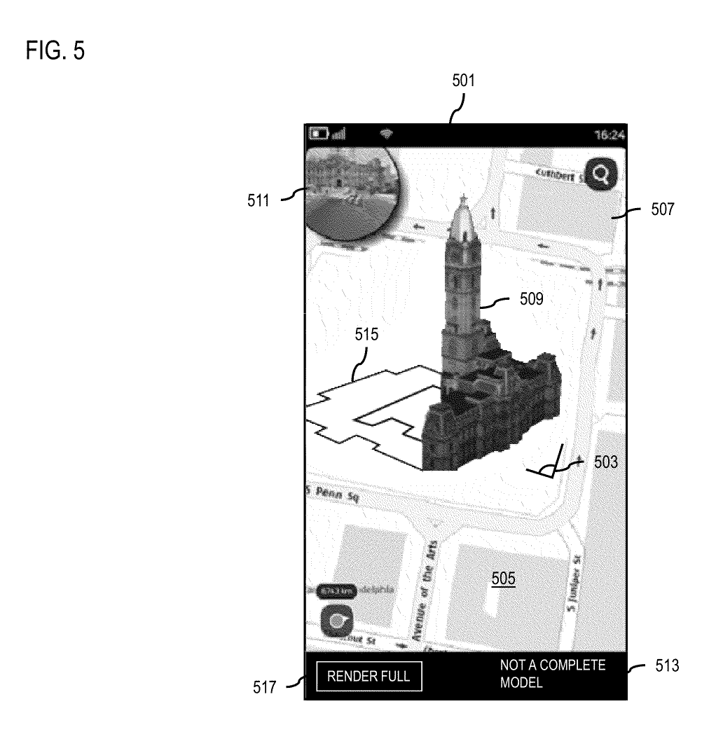

In step 311, the application client 103 optionally causes, at least in part, a presentation of one or more notifications associated with the transformed content, the other content, or a combination thereof. By way of example, the application client 103 can render the transformed object along with the notification “not a complete part of the model” and/or one or more visual clues (e.g., rendering a partial plan of the three-dimensional model). An illustrated example of the one or more notifications is depicted in FIG. 5.

In step 313, the application client 103 causes, at least in part, a rendering of the transformed content for a predetermined period, a duration of one or more contexts, at least the rendering of the other content, or a combination thereof. By way of example, the application client 103 may determine to render the transformed content for a predetermined period (e.g., one to two minutes or the duration of the pre-defined screen timeout), a duration of one or more contexts (e.g., based on the GPS coordinates associated with the mobile device), at least the rendering of the other content (e.g., the running of the augmented and/or mixed reality application) or a combination thereof.

In step 315, the application client 103 determines to override the one or more parameters for transforming the content based, at least in part, on one or more data connections, computational resources, or a combination thereof. By way of example, the application client 103 may determine that a WiFi connection is available or that additional computational resources are available (e.g., the augmented and/or mixed reality application is running on a tablet as opposed to a mobile phone) therefore obviating the requirement to transmit one or more parameters (e.g., bounding box coordinates) to the one or more content servers. As a result, the at least one other provider (e.g., a third-party content provider) would transmit the entire three-dimensional model (e.g., a City Hall building) to the application client 103 for rendering in the augmented and/or mixed reality application.

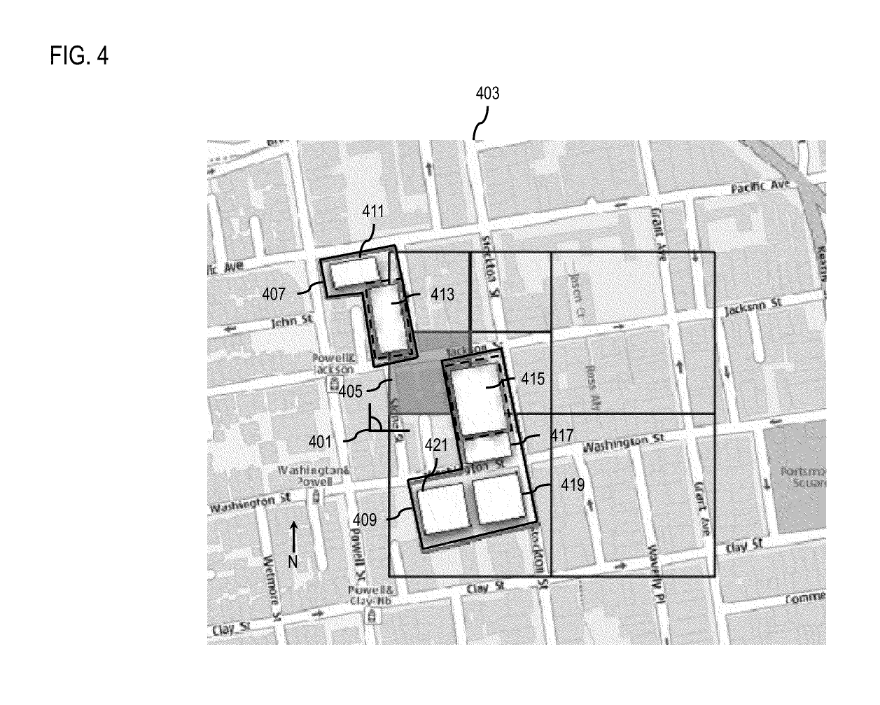

FIG. 4 is a diagram of an example application scenario utilized in the processes of FIG. 3, according to various embodiments. As shown, FIG. 4 illustrates an embodiment of the back-end processes of the system 100 causing a filtering, a clipping, or a combination thereof of one or more objects from the at least one other provider (e.g., a third-party content provider) based on one or more parameters (e.g., a level of detail or a field of view) to determine the transformed content. In a sample use case, an end user 401 is exploring the downtown area of San Francisco while using an augmented and/or mixed reality application on his or her mobile device (e.g., a mobile phone). In one embodiment, the system 100 makes a request to one or more map servers (e.g., a server associated with the mobile device's service provider or carrier) for location-based data (e.g., map data 403) associated with the location of the mobile device by indicating a position or rectangle of interest using one or more location-based technologies associated with the mobile device. Based on the location of the end user 401, the one or more map servers return to the system 100 one or more map tiles (e.g., map tile 405) containing location-based data associated with the area requested. In one embodiment, the system 100 processes the one or more map tiles to determine one or more parameters describing the one or more areas bounded by the one or more map tiles (e.g., a level of detail or a field of view) based on context information associated with the end user 401.

The system 100 then transmits one or more requests for additional content (e.g., three dimensional models, geo-tagged data, user review information, etc.) from at least one other provider (e.g., a third-party content provider) that the system 100 can then use to substitute for, enhance, or a combination thereof the content already provided by the one or more map servers. More specifically, the system 100 determines the at least one other provider, the content, or a combination thereof based on one or more themes for rendering the one or more map tiles (e.g., common tourist attractions).

In this example use case, the system 100 determines that the at least one other provider has one or more matching objects (e.g., geo-data models 407 and 409) stored on one or more content servers corresponding to the requested coordinates that can then be skinned by the system 100 in the augmented and/or mixed reality application. However, the geo-data models 407 and 409 comprise numerous three-dimensional models and are much larger geographically than the area of interest indicated by the system 100. As in this example use case, the geo-data model 407 contains three-dimensional models 411 and 413 and the geo-data model 409 contains three-dimensional models 415, 417, 419, and 421. Based on the level of detail and field of view of the end user 401 (e.g., oriented in a north-east position facing the two buildings represented by the three-dimensional models 413 and 415), the system 100 causes the content server to first filter, clip, or a combination thereof (i.e., transform) the geo-data models 407 and 409 and then transmit back to the system 100 (e.g., using KML) only the three-dimensional models (e.g., three-dimensional models 413 and 415) that are contained in the specified area of interest.

Once the system 100 receives the transformed content (e.g., three-dimensional models 413 and 415), the system 100 can cause a rendering of the transformed content at the mobile device of the end user 401. More specifically, the system 100 incorporates the transformed objects into the scene graph of the augmented and/or mixed reality application and then renders the resulting skinned buildings. As previously discussed, the system 100 may optionally cause a presentation of one or more notifications associated with the transformed content (e.g., “not a complete part of the model”). In addition, the system 100 may cause a rendering of the transformed content for a predetermined period (e.g., one to two minutes), a duration of one or more contents (e.g., based on GPS coordinates associated with the mobile device), at least the rendering of the other content (e.g., map data 403), or a combination thereof. Further, in one embodiment, if the end user 401 was using a tablet computer instead of a mobile phone or if the system 100 determined that a WiFi connection was available, the system 100 may determine to override the one or more parameters for transforming the content (e.g., a level of detail or a field of view). As a result, the at least one other provider would transmit all of the three-dimensional buildings 411, 413, 415, 417, 419, and 421 associated with the geo-data models 407 and 409, respectively, to the system 100 for rendering in the augmented and/or mixed reality application of the mobile device.

FIG. 5 is a diagram of a user interface utilized in the processes of FIG. 3, according to various embodiments. As shown, the example user interface of FIG. 5 includes one or more user interface elements and/or functionalities created and/or modified based, at least in part, on information, data, and/or signals resulting from the process (e.g., process 300) described with respect to FIG. 3. More specifically, FIG. 5 illustrates a user interface (e.g., interface 501) depicting various embodiments. In a sample use case, an end user 503 is exploring the City Hall building of Philadelphia, while using an augmented and/or mixed reality application on his or her mobile device (e.g., a mobile phone). In one embodiment, the system 100 makes a request to one or more map servers (e.g., a server associated with the mobile device's service provider or carrier) for location-based data (e.g., map data) associated with the location of the mobile device by indicating a position or rectangle of interest using one or more location-based technologies associated with the mobile device. Based on the location of the end user 503, the one or more map servers return to the system 100 one or more map tiles containing location-based data associated with the area requested. The location-based data may include map data 505 and outlines of major buildings (e.g., building 507). In one embodiment, the system 100 processes the one or more map tiles returned from the one or more map servers to determine one or more parameters describing the one or more area bounded by the one or more map tiles (e.g., bounding box coordinates, one or more levels of detail, a field of view, or a combination thereof) based on context information associated with the mobile device of end user 503.

The system 100 then transmits one or more requests for additional content (e.g., three-dimensional models, geo-tagged data, user review information, etc.) from at least one other provider (e.g., a third-party content provider) that the system 100 can then use to substitute for, enhance, or a combination thereof the content already provided by the one or more map servers. More specifically, the system 100 determines the at least one other provider, the content, or a combination thereof based one or more themes for rendering the one or more map tiles (e.g., popular tourist destinations).

In this example use case, the system 100 determines that the at least one other provider has one or more matching objects (e.g., a three-dimensional model of City Hall 509) corresponding to the requested coordinates that can be skinned by the system 100 in the augmented and/or mixed reality application. In addition, the at least one other provider also has one or more three-dimensional panoramas 511 corresponding to the location. However, the model 509 and the panorama 511 comprise a rather large three-dimensional model and are much larger geographically than the area of interest indicated by the system 100 (e.g., the east façade of the City Hall building). Therefore, based on the level of detail and view of the end user 503 (e.g., oriented in a north-west position facing the east façade of the City Hall building), the system 100 causes the content server to first filter, clip, or a combination thereof (i.e., transform) the geo-data model and then transmit back to the system 100 (e.g., using KML) only the three-dimensional objects (e.g., the three-dimensional model 509 and panorama 511) that are contained in the specified area of interest.

Once the system 100 receives the transformed content (e.g., the three-dimensional model 509 and panorama 511), the system can cause a rendering of the transformed content at the user interface 501 of the mobile device. More specifically, the system 100 incorporates the transformed objects into the scene graph of the augmented and/or mixed reality application and then renders the resulting skinned building 509 and panorama 511. In addition, the system 100 may optionally cause a presentation of one or more notifications associated with the transformed content. By way of example the one or more notifications may include a written notification 513 (e.g., “NOT A COMPLETE MODEL”) as well as one or more visual clues 515 (e.g., a partial plan of the City Hall building). Further, the system 100 may cause a rendering of the transformed content for a predetermined period (e.g., one or two minutes), a duration of one or more contents (e.g., based on GPS coordinates associated with the mobile device), at least the rendering of the other content (e.g., map data 505), or a combination thereof. Also, in one embodiment, the system 100 may determine based on one or more data connections (e.g., an availability of a WiFi connection) to enable the end user 503 to override the one or more parameters for transforming the content through one or more interactions with the user interface 501 (e.g., by selecting the “RENDER FULL” button 517). As a result, the at least one other provider would transmit the entire three-dimensional model of City Hall as well as the full three-dimensional panorama to the system 100 for rendering in the augmented and/or mixed reality application of the end user 503's mobile device.

The processes described herein for filtering and delivering user-defined virtual content to augmented and/or mixed reality mobile applications may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

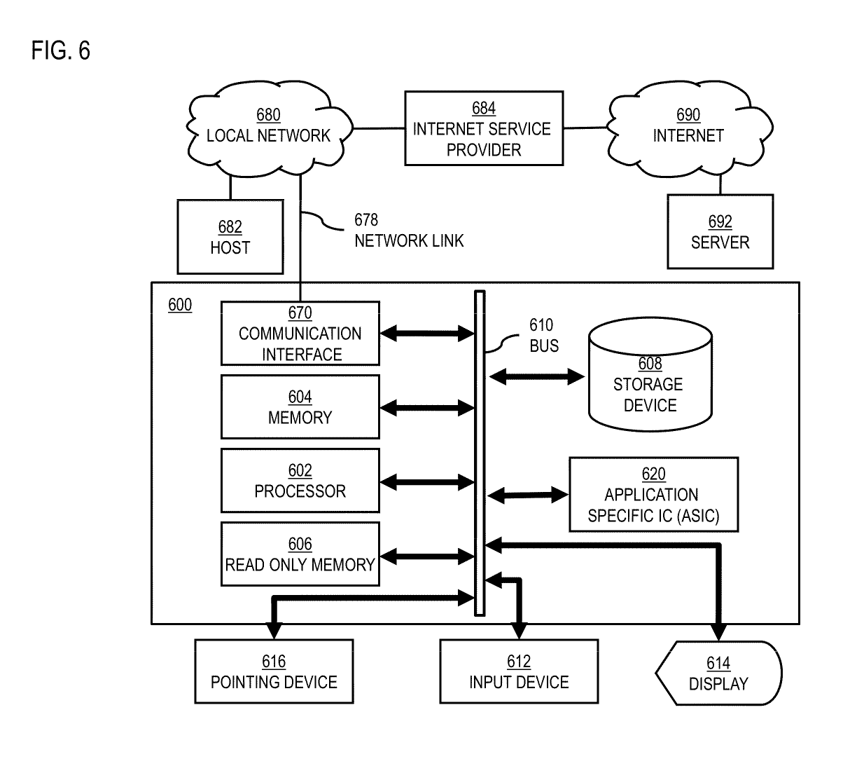

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to filter and deliver user-defined virtual content to augmented and/or mixed reality mobile applications as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of filtering and delivering user-defined virtual content to augmented and/or mixed reality mobile applications.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to filter and deliver user-defined virtual content to augmented and/or mixed reality mobile applications. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for filtering and delivering user-defined virtual content to augmented and/or mixed reality mobile applications. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for filtering and delivering user-defined virtual content to augmented and/or mixed reality mobile applications, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for filtering and delivering user-defined virtual content to augmented and/or mixed reality mobile applications to the UEs 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to filter and deliver user-defined virtual content to augmented and/or mixed reality mobile applications as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of filtering and delivering user-defined virtual content to augmented and/or mixed reality mobile applications.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to filter and deliver user-defined virtual content to augmented and/or mixed reality mobile applications. The memory 705 also stores the data associated with or generated by the execution of the inventive steps.

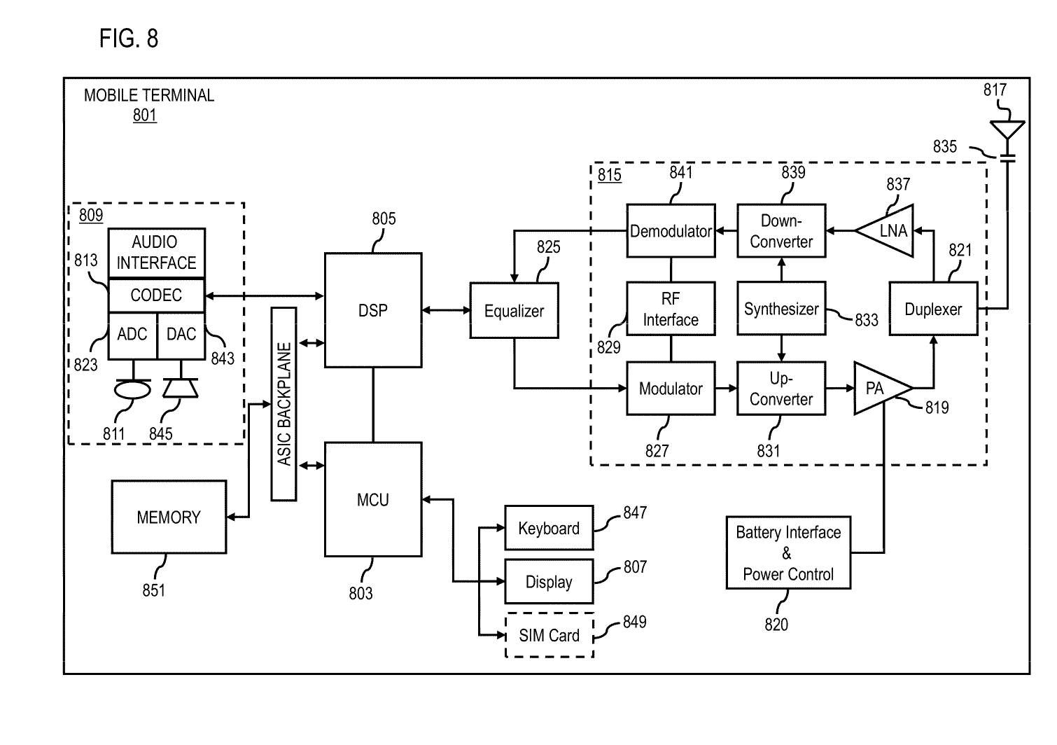

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of filtering and delivering user-defined virtual content to augmented and/or mixed reality mobile applications. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of filtering and delivering user-defined virtual content to augmented and/or mixed reality mobile applications. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to filter and deliver user-defined virtual content to augmented and/or mixed reality mobile applications. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of one or more map tiles to determine one or more parameters describing, at least in part, one or more areas bounded by the one or more map tiles, wherein the one or more map tiles are received from at least one provider; and
a transmission of one or more requests for content to at least one other provider, wherein the one or more requests specify, at least in part, the one or more parameters for transforming the content.

2. A method of claim 1, wherein the (1) data and/or (2) information and/or (3) at least one signal are further based, at least in part, on the following:
a rendering of the transformed content,
wherein the rendering of the transformed content substitutes for, enhances, or a combination thereof other content associated with the one or more map tiles.

3. A method of claim 2, wherein the (1) data and/or (2) information and/or (3) at least one signal are further based, at least in part, on the following:
at least one determination of the at least one other provider, the content, or a combination thereof based, at least in part, on one or more themes for rendering the one or more map tiles.

4. A method of claim 1, wherein the (1) data and/or (2) information and/or (3) at least one signal are further based, at least in part, on the following:
a filtering, a clipping, or a combination thereof of one or more objects from the at least one other provider based, at least in part, on the one or more parameters to determine the transformed content.

5. A method of claim 1, wherein the content includes, at least in part, model data, geo-tagged data, or a combination thereof.

6. A method of claim 1, wherein the one or more parameters include, at least in part, one or more bounding box coordinates, one or more levels of detail, at least one field of view, or a combination thereof based, at least in part, on context information associated with a device rendering the transformed content.

7. A method of claim 2, wherein the (1) data and/or (2) information and/or (3) at least one signal are further based, at least in part, on the following:
a rendering of the transformed content for a predetermined period, a duration of one or more contexts, at least the rendering of the other content, or a combination thereof.

8. A method of claim 2, wherein the (1) data and/or (2) information and/or (3) at least one signal are further based, at least in part, on the following:
a presentation of one or more notifications associated with the transformed content, the other content, or a combination thereof.

9. A method of claim 1, wherein the (1) data and/or (2) information and/or (3) at least one signal are further based, at least in part, on the following:
at least one determination to override the one or more parameters for transforming the content based, at least in part, on one or more data connections, computational resources, or a combination thereof.

10. A method of claim 7, wherein the other content includes, at least in part, content associated with one or more augmented and/or mixed reality applications.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of one or more map tiles to determine one or more parameters describing, at least in part, one or more areas bounded by the one or more map tiles, wherein the one or more map tiles are received from at least one provider; and
cause, at least in part, a transmission of one or more requests for content to at least one other provider, wherein the one or more requests specify, at least in part, the one or more parameters for transforming the content.

12. An apparatus of claim 11, wherein the apparatus is further caused to:
cause, at least in part, a rendering of the transformed content,
wherein the rendering of the transformed content substitutes for, enhances, or a combination thereof other content associated with the one or more map tiles.

13. An apparatus of claim 12, wherein the apparatus is further caused to:
determine the at least one other provider, the content, or a combination thereof based, at least in part, on one or more themes for rendering the one or more map tiles.

14. An apparatus of claim 11, wherein the apparatus is further caused to:
cause, at least in part, a filtering, a clipping, or a combination thereof of one or more objects from the at least one other provider based, at least in part, on the one or more parameters to determine the transformed content.

15. An apparatus of claim 11, wherein the content includes, at least in part, model data, geo-tagged data, or a combination thereof.

16. An apparatus of claim 11, wherein the one or more parameters include, at least in part, one or more bounding box coordinates, one or more levels of detail, at least one field of view, or a combination thereof based, at least in part, on context information associated with a device rendering the transformed content.

17. An apparatus of claim 12, wherein the apparatus is further caused to:
cause, at least in part, a rendering of the transformed content for a predetermined period, a duration of one or more contexts, at least the rendering of the other content, or a combination thereof.

18. An apparatus of claim 12, wherein the apparatus is further caused to:
cause, at least in part, a presentation of one or more notifications associated with the transformed content, the other content, or a combination thereof.

19. An apparatus of claim 11, wherein the apparatus is further caused to:
determine to override the one or more parameters for transforming the content based, at least in part, on one or more data connections, computational resources, or a combination thereof.

20. An apparatus of claim 17, wherein the other content includes, at least in part, content associated with one or more augmented and/or mixed reality applications.

21-48. (canceled)
